(19) United States
(12) Patent Application Publication
(10) Pub. No.: US 2011/0196887 A1
(43) Pub. Date: Aug. 11, 2011

(54) Light-Weight Network Traffic Cache

(75) Inventor: Aleksandr V. Kennberg, Waterloo (CA)

(73) Assignee: Google Inc., Mountain View, CA (US)

(21) Appl. No.: 12/701,900

(22) Filed: Feb. 8, 2010

(51) Int. Cl. G06F 17/30; G06F 15/16

(52) U.S. Cl. 707/769; 709/223; 707/792; 709/203; 707/E17.01; 707/E17.014

(57) ABSTRACT

The present invention relates to methods and apparatus for providing a light-weight network traffic cache. A network traffic cache apparatus includes a database, a device I/O module, an application and a traffic cache manager. The device I/O module may send and receive information to and from a server device through the device I/O module. The application is configured to submit a request for information substantially simultaneously to both the device I/O module and the traffic cache manager. The traffic cache manager is configured to provide information to the application in response to the request for information. The information may be retrieved from the database.

### FIELD

The present application generally relates to the performance of mobile web applications.

### BACKGROUND

User experience is a key concern for mobile web applications. In particular, reducing the perceived latency in the response to network requests is critical to providing a good user experience. Users are keenly sensitive any latency between the need of a mobile application for data from the network and the display of that information.

One example of a frequent recurring need for user data by a mobile application occurs at mobile application startup. The user experience can be dramatically impacted if a user perceives a delay in the startup of a mobile application. Waiting for a mobile application to display relevant user data can greatly delay the startup of a mobile application. Another example of a recurring need for user data by an application occurs when a user switches from one application function to another, e.g., switching from a social graph display to a calendar display.

Conventional approaches to displaying data may involve the use of a conventional cache to display older data in lieu of fresh network data. Because of the characteristics of conventional caches however, use of a conventional caching approach may not provide a response with low latency.

Conventional cache use generally involves complex instructions to retrieve pieces of required information. These complex cache requests can delay access to cached information and fail to improve the user experience of mobile applications. In addition, when the responses to the individual cache requests are retrieved, they may be in a format that is different from the result provided by the network request. This format difference can reduce the processing speed and increase latency. Complex cache requests can also cause a mobile application to require more code, and more code takes longer and requires more memory to execute.

Accordingly, what is needed are new methods and apparatus providing a light-weight network traffic cache for accelerating the perceived response from a network and improving the user experience.

### BRIEF SUMMARY

Embodiments of the present invention relate to methods and apparatus for providing a light-weight network traffic cache. According to an embodiment, a network traffic cache apparatus includes a database, a device I/O module, an application and a traffic cache manager. The device I/O module may be coupled to a server device. An application may be coupled to the device I/O module that may send and receive information to and from the server device through the device I/O module. The traffic cache manager may be coupled to the application, the device I/O module and the database. The application is configured to submit a request for information substantially simultaneously to both the device I/O module and the traffic cache manager. The traffic cache manager is configured to provide information to the application in response to the request for information. The information may be retrieved from the database.

According to another embodiment, a method of improving an application user experience with a light-weight network traffic cache is provided. The method includes submitting, with an application on a device, a request for information to a server device, the request for information being of a first type of request. The method further includes receiving information responsive to the request for information at both the application and a traffic cache manager on the device and storing, with the traffic cache manager, the information in a database on the device. Finally, the method includes, upon starting up of the application, substantially simultaneously sending a request for information to both the server device and the traffic cache manager, the request for information being of the first type of request, retrieving, by the traffic cache manager, information from the database responsive to the request for information, and sending by the traffic cache manager, the information responsive to the request for information to the application.

Further features and advantages, as well as the structure and operation of various embodiments are described in detail below with reference to the accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a system according to an embodiment of the present invention.

FIG. 2 is a more detailed diagram of a system according to an embodiment of the present invention.

FIG. 3 is a detailed diagram of a system according to an embodiment of the present invention.

FIG. 4 is a timeline showing events associated with network requests according to an embodiment of the present invention.

FIG. 5 is a timeline showing events associated with cache requests according to an embodiment of the present invention.

FIG. 6 is a flowchart of a computer-implemented method of improving the user experience of an application according to an embodiment of the present invention.

FIG. 7 depicts a sample computer system that may be used to implement one embodiment.

### DETAILED DESCRIPTION OF EMBODIMENTS

Embodiments of the present invention relate to providing methods and apparatus for a light-weight network traffic cache. Different approaches are described that allow embodiments, for example, to accelerate the response from a network to a mobile application.

While specific configurations, arrangements, and steps are discussed, it should be understood that this is done for illustrative purposes only. As would be apparent to a person skilled in the art given this description, other configurations, arrangements, and steps may be used without departing from the spirit and scope of the present invention. As would be apparent to a person skilled in the art given this description, that these embodiments may also be employed in a variety of other applications.

It should be noted that references in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art given this description to incorporate such a feature, structure, or characteristic in connection with other embodiments whether or not explicitly described.

### Overview

One technique used by an embodiment to improve the user experience of applications is to use a local database on a device as a light-weight network traffic cache. All previous network requests can be simply stored by a network traffic cache manager in the database without modification. When network data is required, such as at application startup, a request to both the network and local database are initiated by embodiments. This request to both the network and the local database is termed herein to be “substantially simultaneously.”

As would be appreciated by one having skill in the art, this term “substantially simultaneously as used herein, signifies that the requests are being made by the application code at the same time. As would also be appreciated by one having skill in the art, because of the nature of network communications and the features of the network traffic cache described herein, if the network channel of communication is unavailable, e.g., a cell phone with no service, the network request may not be successfully made to the server in embodiments. In this case of an unsuccessful transmission of the request to the server, the database can still return relevant information.

Typically in an embodiment, the request to the local database is returned much faster (milliseconds versus seconds), and this response is used to populate previously stored data into the application so the application appears to have retrieved network data much faster than if the application had paused to wait for the network data. Once the network data is received from the network, in an embodiment it can be used to update the displayed data. In an embodiment, the applications that use embodiments of the traffic cache described herein are mobile applications executing on a client device, such device being termed a client device.

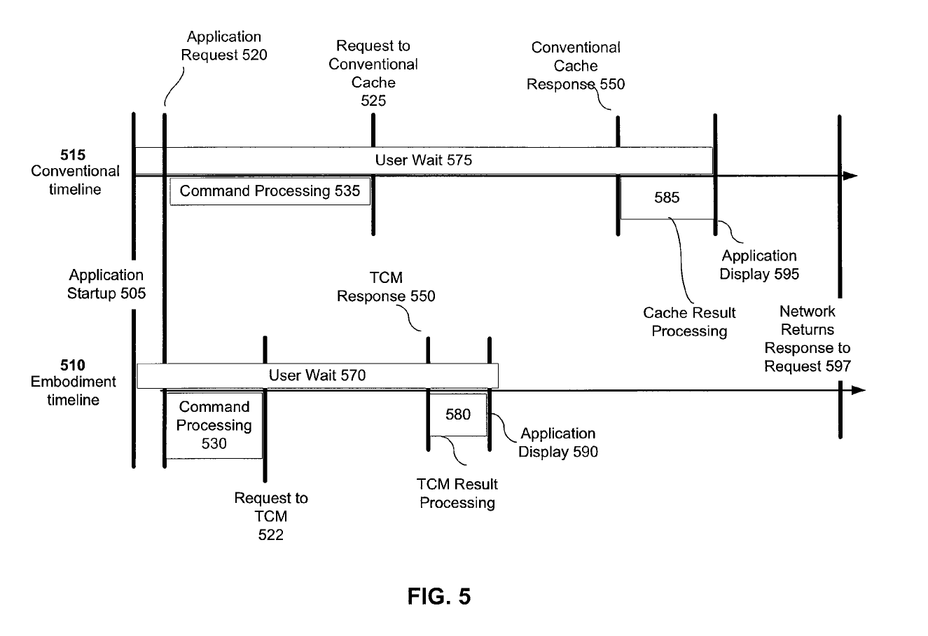

As discussed below with FIG. 5, a characteristic of an embodiment of the implementation described above is that it is “light-weight,” e.g., the code that generates the requests and handles the responses from network is more simple, and smaller than is generally used for cache requests. The simplicity of the requests themselves, the format in which the responses are returned and the level of processing that is required by the request responses, in embodiments, also may be termed “light-weight.” Advantages of this light-weight characteristic are described below.

The terms “application startup,” and “startup,” are used herein to broadly describe starting up a software application. For example, such a start up may occur when the application is opened or selected to run. This start up may be the first time the application is started. This start may also be a startup subsequent to a closing of the application (also called a “next start up”). In other words, an earlier run of the application may have occurred and the application may have been previously closed.

Embodiments described herein for light-weight network traffic cache can reduce real-world mobile application startup time. Without such an improvement, a user would first have to wait for the application to start, and then wait for application data to be fetched from a remote server. As described below, retrieving unparsed network requests in advance of a received network response can improve the application experience for the user in some cases.

For the user, the perception that a mobile application has started up may occur at the time relevant information is displayed on a user interface. In some cases, even the display of older data at this startup point has the effect of giving the user a perception that the mobile application has started.

The term “database” is used herein to broadly describe a “local” or “client-side” database stored on a device along with an executing application. An example of such a database is the “Web SQL Database,” also known as the “Web Database,” “Local Database” and “Client-Side” database, defined as a part of the HTML5 specification. As would be apparent to a person skilled in the art given this description, other data storage solutions could also be used without departing from the spirit and scope of the present invention.

A “server” as used herein, and as will be appreciated by persons skilled in the relevant art, may be running on one or more service devices, such devices being computing devices networked or in a cluster of computing devices operating in a cluster or server farm.

### System 100

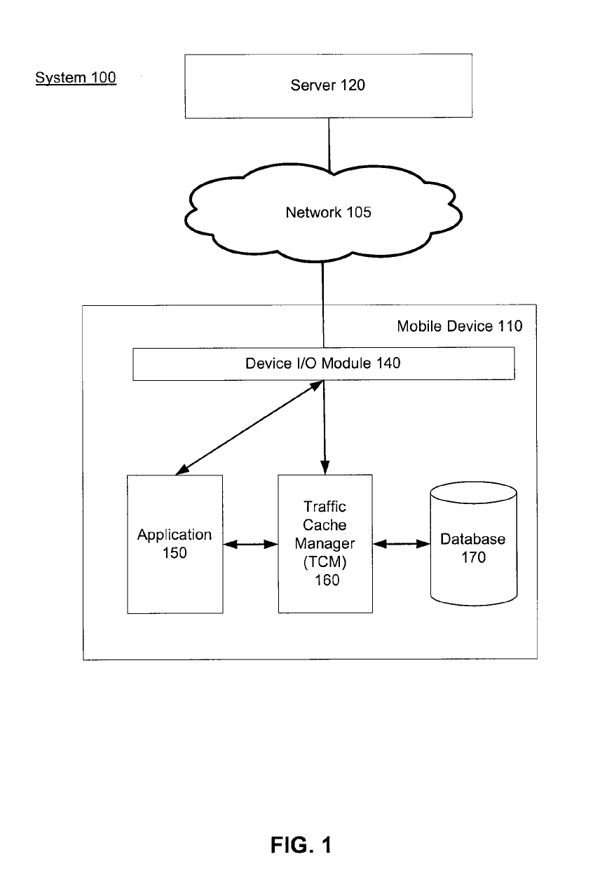

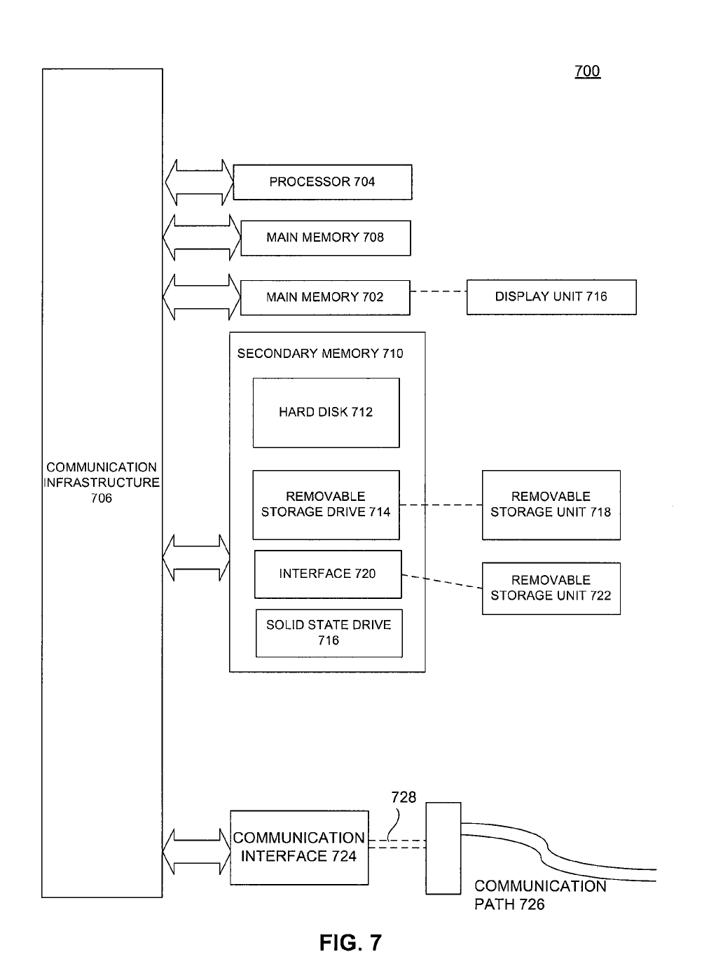

FIG. 1 illustrates an embodiment of a system 100 for improving the performance of an application. According to an embodiment, system 100 includes a mobile device 110 and server 120. Mobile device 110 includes device input/output (I/O) module 140, application 150, traffic cache manager (TCM) 160 and database 170. These components may be coupled directly or indirectly. Device I/O module 140 may be coupled to one or more networks 105. As used herein, mobile device 110 can be any of the computer systems referenced below with the description of FIG. 7.

Device input/output (I/O) module 140, application 150, TCM 160 and database 170 may exist within or be executed by hardware in a computing device. These components for example, TCM 160, may be software, firmware, or hardware or any combination thereof in a computing device. As detailed further below in the description of FIG. 7, a computing device can be any type of computing device having one or more processors.

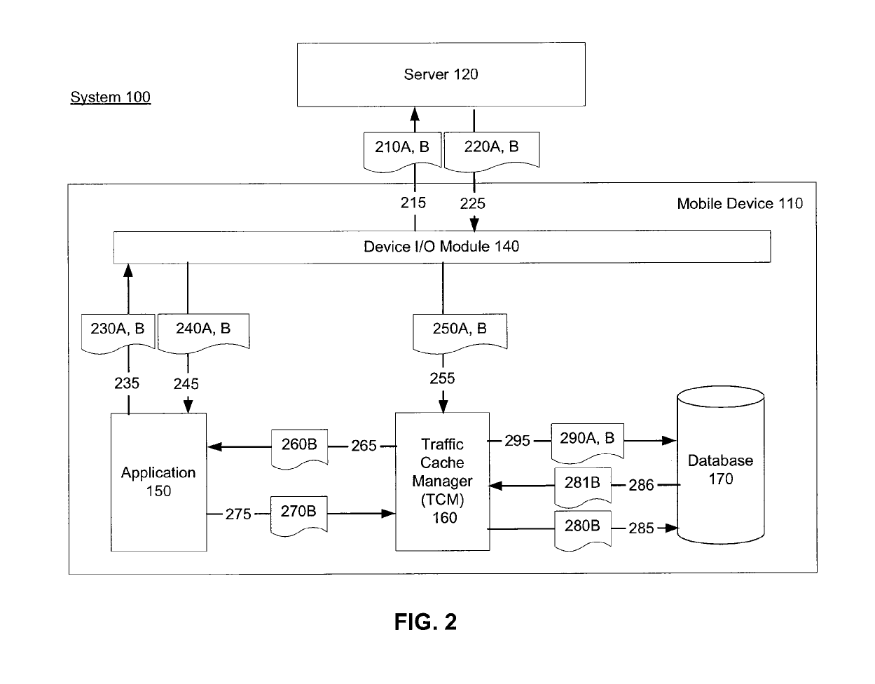

FIG. 2 is a more detailed depiction of system 100 showing the data messages exchanged between the coupled modules. System 100 contains links 235 and 245 coupling application 150 to device I/O module 140, links 265 and 275, coupling application 150 to TCM 160, links 285 and 295, coupling TCM 160 to database 170, link 255 coupling TCM 160 to device I/O module 140 and links 215 and 225, coupling device I/O module to network 105.

In FIG. 2, data messages 210, 220, 230, 240 and 250 are discussed herein generally with reference to the number listed, e.g., 210, 220, and with respect to a specific example embodiment by adding (A) or (B) to the number listed, e.g., 210A, 210B, 220A, 220B. As described below, example (A) refers to a first network request and response, and example (B) refers to a second network request and response. Components 270, 280 and 290 are referenced in a similar fashion, but only are referenced with respect to one of the (A) or (B) examples, though this does not indicate that these components could not be used in the example not referenced.

In an embodiment, link 235 is used by application 150 to relay a network request 230 for data, e.g., data to be displayed on the user interface of application 150. An example of network request 230A is a request for an updated social graph by a social networking application executing as application 150. In an example, application 150 is a social networking application wherein a social graph is displayed for a user, e.g., TWITTER by Twitter, Inc. of San Francisco, Calif. The user experience of such an application is affected by how quickly the application displays, for example upon startup, relevant and useful data.

At the time link 235 is used, a user may be waiting for the display of mobile application to display data, e.g., their social graph. In an example, the user is waiting at the startup of application 150 for their social graph to be displayed. Additional actions that occur in an embodiment at the time network request 230 is relayed are discussed below.

In an embodiment, device I/O module 140 relays network request 230 to server 120 via link 215 as network request 210, and network response 220 is relayed from server 120 in response to network request 210 via link 225 to device I/O module 140. Device I/O module 140 relays this network response 220 to application 150 via link 245 as network response 240. In an embodiment, network response 220 and network response 240 are substantially the same, not being modified, processed or parsed by device I/O module 140. Network responses 220 and 240 generally are strings of unparsed data that are parsed by application 150 and displayed.

In an example, network requests 230A and 210A are requests for updated social graphs, and network responses 220A, 240A are an unparsed social graph for a social networking application executing as application 150. Once parsed by application 150, the social graph is displayed.

### Caching Data in Database 170

In an embodiment, occurring substantially simultaneously with the transfer of network response 240 via link 245, network response 250 is transferred via link 255 to TCM 160. In an embodiment, network response 220 and 250 are substantially the same, not being modified, processed or parsed by device I/O module 140. In an embodiment, not all network responses 220 are relayed via link 255 to TCM 160. Certain network responses 220 may have lower priority, be associated with applications that don't use TCM 160 or have other similar characteristics.

In an embodiment, upon receipt of network response 250, TCM 160 stores network response 250 via link 295 in database 170 as database store command 290. In an embodiment, database store command 290 stores data that is substantially the same as network response 250, the data stored not being modified, processed or parsed by TCM 160. In an embodiment, not all network responses 250 are relayed via link 295 to database 170. Certain network responses 250 may have lower priority, be associated with applications that don't use TCM 160 or have other similar characteristics. As would be appreciated by one skilled in the art given this description, other embodiments of TCM 160 could advantageously modify the data contained in network response 250 before storage in database 170.

In an example, the data contained in network responses 250A and database store command 290A are an updated social graph responsive to network request 230A from application 150.

Network requests 230 and 210 and network responses 220, 240 and 250 are associated with a particular network request/response type. One example of network request (230A)/response (220A) type, is the “social graph” request/response. Upon the issuance of database store command 290 to database 170, the type network response is stored along with the data related with network response 250. In an embodiment, this stored request/response type may be coded in network response 250 or may be determined by TCM 160.

In an embodiment, if, at the time database store command 290 is issued, no value is stored in database 170 for the particular response type in the command, a new database record is created for the new type, containing the data relayed in network response 250. In an embodiment, if, at the time database store command 290 is issued, a value exists in database 170 for the particular response type in the command, then the value for the type in database store command 290 replaces the existing value in database 170. As would be appreciated by one with skill in the art, another embodiment could keep different versions of the response type in the database.

In an example, because the type of network request 230A corresponds to a request for an updated social graph, the type of network response 220A, 250A and 290A corresponds to a request for an updated social graph as well. In an example, database 170 does not contain a value for the “social graph” response, and thus a new record is inserted into database 170 for this response type.

In an embodiment, database 170 is a conventional relational database with rows and columns, and database store command 290 stores data as follows: each row corresponds to a different type of network response, and a first column contains a code corresponding to the response type, while a second column stores the network response. In an embodiment, the portion of the network response stored in the second column is unparsed.

Table 1 below shows an example database table stored in database 170. In an embodiment, the “ID” column corresponds to the network response type and the “DATA” column corresponds to a brief description of the network response data stored in the column:

TABLE 1

| ID | DATA |
|---|---|
| 1 | A JavaScript Object Notation (JSON) string representing JavaScript |
| | objects that contain user content. |
| 2 | A geographic location represented by latitude, longitude and |
| | accuracy. |
| 3 | A delimited list of place names near the geographic location stored |
| | at ID = 2. |
| 4 | A user name and a URL linking to a user photo. |

The above table is illustrative and not intended to be limiting of embodiments. Other structures, stored values and methods of storage can be used by embodiments.

In an example, upon receipt of network response 250A and using the information in database store command 290A, TCM 160 inserts a record in database 170 with a first field the denotes a code corresponding to “request updated social graph” type and a second field that contains the unparsed social graph information.

Retrieving Data from Database 170

Turning to the retrieval of data from the TCM 160, in an embodiment, substantially simultaneously with the time network request 230 is being relayed on link 235, TCM request 270 is relayed by application 150 to TCM 160 via link 275. In an embodiment, network request 230 and 270 are substantially the same, each requiring similar processing in their generation. In an embodiment, TCM request 270 is a request for a network response stored in database 170 that corresponds to the simultaneously transmitted network request 230.

One benefit of embodiments described herein, is the simplicity of TCM request 270. Conventional methods of retrieving cached information may involve complex instructions generated using processes that differ from the generation of network requests. Conventional caching approaches may retrieve stored, parsed data using complex queries. In an embodiment, TCM request 270 is sought to be as simple, small and rapidly formed as possible so as to reduce the time it takes to produce relevant data from database 170. In addition, an embodiment, by having network request 230 and TCM request 270 be substantially similar, processing time in generating the requests can be reduced.

In an example, application 150 is coded using JavaScript, such code generally requiring parsing to be utilized. One concern for developers who are developing mobile applications, such as the application 150, is the amount of code, for instance JavaScript, that must be parsed before a network or cache request may be processed. Having TCM request 270 be simplified and involving smaller amounts of code allows, in an example, the JavaScript making up the commands to be parsed faster and therefore execute faster. In an embodiment, this faster execution leads to a faster display of user data.

In an embodiment, once TCM 160 receives TCM request 270, TCM 160 requests information 280 from database 170 that corresponds to the type of network/TCM request 230/270 conveyed by application 150. Upon receipt of the request for information 280, database 170 either produces database response 281 responsive to TCM request 270 or returns an indication that no responsive data is available for the request type. If database response 281 data is available, then TCM 160 receives it and generates TCM response 260 relayed to application 150. In an embodiment, if no database response 281 is available then TCM 160 signals this result to application 150, and application 150 waits for network response 240 to display responsive data.

In an embodiment, the information conveyed in database response 281 and TCM response 260 corresponds to an unparsed network response of a type corresponding to network request 230, and application 150, upon receipt of TCM response 260 parses the information contained therein in a substantially similar fashion as it parses network response 240. In an embodiment, such substantial similarity in processing between network response 240 and TCM response 260 further reduces the amount of code required to be used in application 150.

In an embodiment, at render time by application 150, the received TCM response 260 is parsed and displayed on the application 150 user interface. The format of the TCM response 260 depends on the mobile application requirements. Formats include JSON (string of text representing JavaScript objects), delimited lists, URLs referencing external content, global positioning system (GPS) coordinates, and raw bytes converted to base64. The preceding list of formats is illustrative and not intended to limit embodiments.

Returning to the “social graph” example, after network response 240A is finally received by application 150, a user views the social graph displayed by application 150 and then shuts down application 150.

In an example, upon the next startup after the noted shut down above, the user wants application 150 to startup as quickly as possible with their social graph displayed. In an example, this display of a social graph may be the “touchstone” of the startup for many users—meaning that the user may perceive that the application has started after this display event occurs.

In response to the application startup event, in an example, application 150 sends out network request 230B, this request corresponding to the same type of network request (“social graph”) as the previously discussed network request 230A.

In an example, to give the user the perception that the application has started (by displaying relevant information of the “social graph” type requested in network request 230B), application 150 simultaneously sends TCM request 270B to TCM 160, and TCM 160 sends database request 280B to database 170 requesting a value for an ID corresponding to response “social graph.”

Because a social graph value was previously stored in response to network request 230A, database returns database response 281B having the value stored by database store command 290A. Database response 281B is forwarded to application 150 as TCM response 260B, and this response is parsed and displayed by application 150. Later, when network response 240B is forwarded to application 150, the older values displayed on the user interface in response to TCM response 260B are replaced by the fresher 240B data. In addition, to store the new value for request type “social graph” network response 250B is forwarded to TCM 160 where database store command 290B replaces the “social graph” value in database 170 with the new value.

### System 101: TCM as a Caching Layer

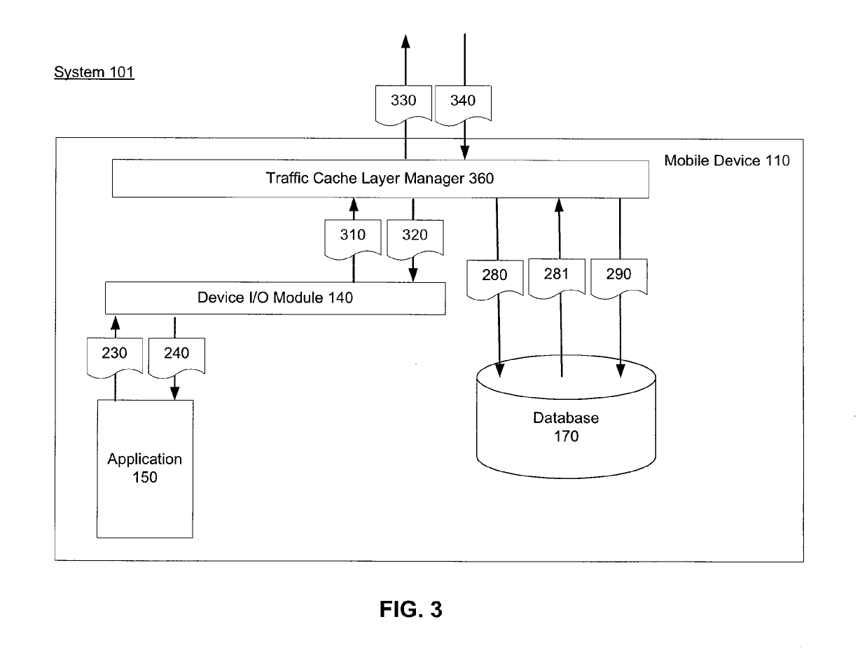

As shown on FIGS. 1 and 2, TCM 160 is depicted as a component coupled to application 150, device I/O module 140 and database 170. In an embodiment, FIG. 3 depicts system 101 with TCM 160 oriented as TCM layer 360. In an embodiment, system 100 and TCM layer 360 generally have the same function as system 100 and TCM 160 described in the sections above detailing FIGS. 1 and 2, but with the following additional characteristics. Components shown on FIG. 3 with reference numbers first used on FIG. 1 (140, 150, 170) and FIG. 2 (230, 240, 280, 281, 290) have similar functions to those described on FIGS. 1 and 2 respectively.

In an embodiment of system 101, network request 230 is still relayed to device I/O module 140, but instead of device I/O module 140 being coupled to network 105, device I/O module 140 is coupled to TCM layer 360. When network request 230 is forwarded by device I/O module 140 as network request 310 to TCM layer 360, TCM layer 360 not only forwards the network request 310 to network 105 (as network request 330), it also starts the processes described in the “Retrieving Data from Database 170” section above.

In an embodiment, because TCM layer 360 is a layer that receives network requests, application 150 no longer has to generate TCM request 270 as in system 100 depicted on FIG. 2. In an embodiment, because only a single request is generated by application 150, and handled by TCM layer 360, additional benefits from simpler, smaller code are realized.

Similarly, in an embodiment, when network response 340 is received, TCM layer 360 is able to forward network response 320 to device I/O module 140 and also generate database store command 290 to directly store network response 340, in a fashion similar to that described with FIG. 2 in the “Caching Data in Database 170” section above. An embodiment may realize additional efficiencies because, as shown on FIG. 3, network response 340 is not routed through device I/O module 140 before being stored in database 170.

Other variations of component placement would be known by one with skill in the relevant art, including having both device I/O module 140 and TCM layer 360 connected to network 105.

### Illustrative Timelines

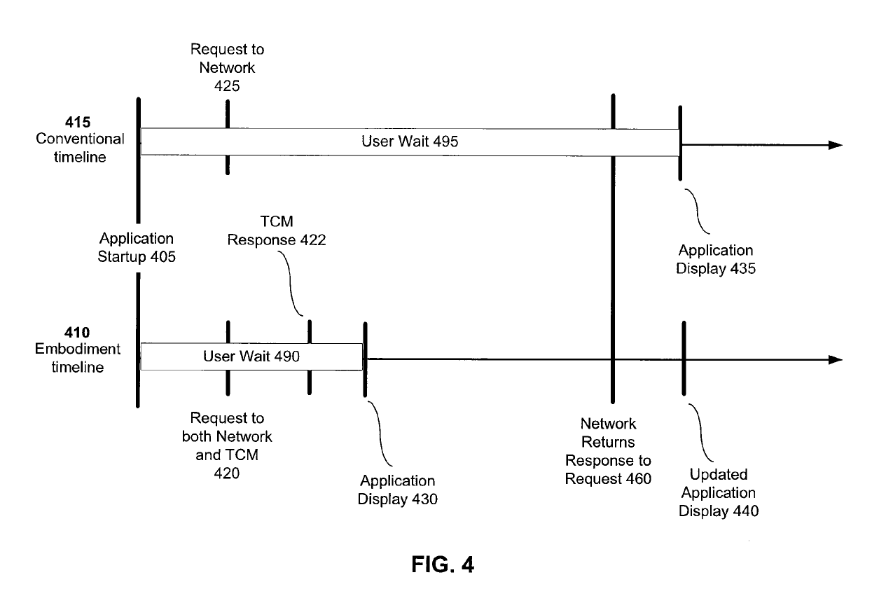

FIG. 4 depicts two timelines showing example events according to an embodiment. Timeline 410 depicts events that follow the processes used by an embodiment, and timeline 415 depicts events according to a conventional approach to requests for data from a network by a mobile device.

Conventional timeline 415 includes application startup point 405, request to network 425, network returns response to request 460, application display 435, and user wait 495 interval. Embodiment timeline 410 includes application startup point 405, request to both network and TCM 420, TCM response 422, application display 430, network returns response to request 460, updated application display 440 and user wait 490 interval.

Both timelines (410, 415) start at point 405 with a requirement by application 150 for information from server 120. In an embodiment, this is the startup of application 150, but it could be any time data from server 120 is required by application 150. As discussed above, startup time is especially critical for the user experience because at that time, generally no data is displayed for the user to view.

Point 405 marks the beginning of user wait (490, 495) on both timelines. This user wait (490, 495) is a time period wherein a user is not viewing any data responsive to the requirement noted above. At startup, this user wait (490, 495) is a period where a user has started the application, but certain data is not displayed.

On conventional timeline 415, after point 405 a network request is forwarded at point 425 by application 150 to request to device I/O module 140 wherein this module forwards the request via network 105 to server 120. At point 460, data responsive to the network request is received by device I/O module 140 and forwarded to application 150 for display. At point 435 on conventional timeline 415, user wait 495 ends and relevant data is displayed in the application 150 user interface. This data is not only relevant to the application, it is up to date as of the information on server 120.

As discussed above, even if additional processing is required to fully start application 150, it is at this point 435 that a user perceives application 150 as started.

On timeline 415, after point 405 a network request is forwarded at point 420 by application 150 (as with point 425) to request to device I/O module 140 wherein this module forwards the request via network 105 to server 120. In addition to the above noted steps however, timeline 410 illustrates how embodiments described herein also submit a request to TCM 160. In an embodiment, as depicted on FIG. 1B, this request is identical in substance to the request sent to device I/O module 140, so no extra processing is required. In an embodiment, TCM 160 may receive this network request, not directly from application 150, but from device I/O module 140.

After point 420, TCM 160 requests data from database 170 responsive to the network request. As point 422, in an embodiment, TCM 160 receives a response from database 170 and forwards the response to application 150 for display. At point 430, user wait 490 ends and relevant information is presented on the user interface of application 150.

In contrast to the relevant information displayed at point 435 on conventional timeline 415, this relevant information is not up to date as of the information stored on server 120. The information stored at point 430 is the information retrieved from database 170. On balance however, in embodiments, the user's enjoyment in seeing relevant, albeit older, application information may outweigh the users displeasure in waiting for relevant and current information.

After point 420, where a request is forwarded to both network TCM 160 and device I/O module 140, on timeline 410, as with conventional timeline 415, the request to server 120 is processed in a conventional fashion. At point 460, device I/O module 140 returns relevant, current information responsive to the network request from server 120. It is worth noting that the time interval for network requests (420, 425) on the respective timelines (410, 415) is represented as taking the same time interval for completion. On timeline 410, it is the application display 430 of relevant information that is accelerated not the interval to return the current data.

FIG. 5 depicts two timelines showing example events according to an embodiment. Timeline 510 depicts events that follow the processes used by an embodiment, and timeline 515 depicts events according to a conventional approach to utilizing a cache on mobile device 110. FIG. 5 illustrates the differences in parsing between an embodiment and a conventional approach.

Conventional timeline 515 includes application startup 505, application request 520, request to conventional cache 525, conventional cache response 550, application display 595, user wait 575 interval, command processing 535 interval and cache result processing 585 interval. According to an embodiment, embodiment timeline 510 includes application startup 505, application request 520, request to TCM 522, TCM result response 550, application display 590, user wait 570 interval, command processing 530 interval and TCM result processing 580 interval.

Point 505 marks the beginning of user wait (570, 575) on both timelines. This user wait (570, 575) is a time period wherein a user is not viewing any data responsive to the requirement noted above. At startup, this user wait (570, 575) is a period where a user has started the application, but certain data is not displayed.

The command processing 530 Interval, between request 520 and request to TCM 522, is the interval wherein the code in application 150 that generates the TCM request (shown as TCM request 270 on FIG. 2), generates the TCM request 270 and submits it to TCM 160.

As discussed above with respect to network request 230 and TCM request 270 from FIG. 2, in an embodiment the request submitted to server 120 is substantially similar to the network TCM request 270 submitted to TCM 160. In an embodiment this substantial similarity means that the same code in application 150 that handles network request 230 can also handle TCM request 270, and this can simplify the code required in application 150. This simplified processing in an embodiment can also speed up the command processing 530, making the command processing 530 interval shorter, thereby displaying results at application display 590 point faster.

The TCM result processing 580 Interval, between TCM response 550 and application display 590, is the interval wherein the code in application 150 that handles the response (shown as TCM response 260 on FIG. 2), processes the response and displays it at application display 590. A similar result processing interval is depicted at cache result processing 585 interval on conventional timeline 515.

As discussed above with respect to database store command 290 and TCM response 260 from FIG. 2, in an embodiment the response returned from TCM 160 is substantially similar to the response expected in response to network request 230. In an embodiment this substantial similarity means that the same code in application 150 that handles network response 240 can also handle TCM response 260, and this can simplify the code required in application 150. This simplified processing in an embodiment can also speed up the result processing, making TCM result processing 580 interval shorter, thereby displaying results at application display 590 point faster.

In an embodiment, simplified code in application 150 can lead to the following beneficial results:
1) Smaller code and thus a smaller application taking up less memory.
2) Smaller code and thus a faster application startup leading to a faster display of user data thereby improving the user experience.
3) Simplified code can lead to easier mobile application development.

### Method

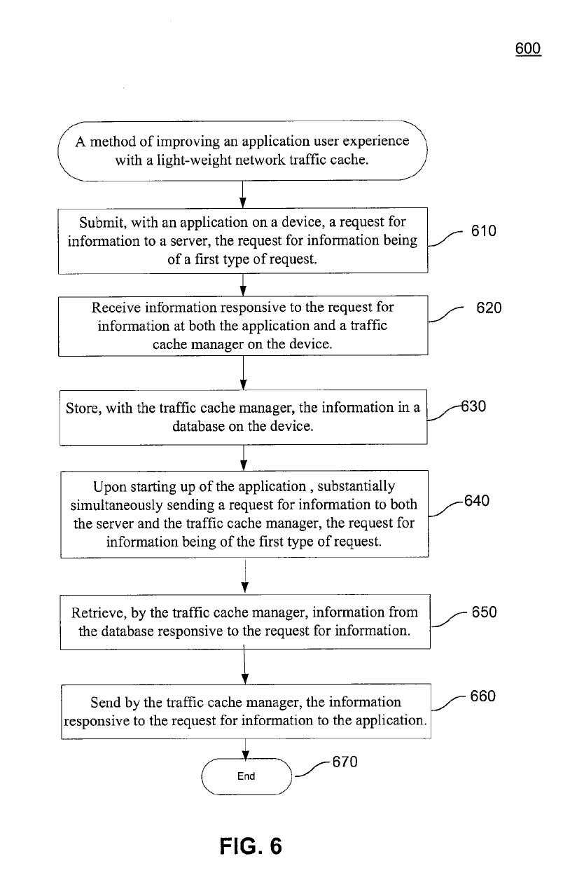

FIG. 6 illustrates a more detailed view of how embodiments described herein may interact with other aspects of embodiments. In this example, initially, as shown in stage 610, an application submits a request for information to a server, the request for information being of a first type of request. In stage 620, information responsive to the request for information is received at both the application and a traffic cache manager. In stage 630, the traffic cache manager stores the received information in a database. In stage 640, upon starting up of the application, substantially simultaneously sending a request for information to both the server and the traffic cache manager, the request for information being of the first type of request. In stage 650, the traffic cache manager retrieves the information from the database responsive to the request for information. In the final stage, stage 660, the traffic cache manager sends the information responsive to the request for information to the application.

### Example Computer System Implementation

FIG. 7 illustrates an example computer system 700 in which embodiments of the present invention, or portions thereof, may be implemented as computer-readable code. For example, system 100 and TCM 160 of FIGS. 1 and 2, carrying out stages of method 600 of FIG. 6, system 101 and TCM layer 360 of FIG. 3 may be implemented in computer system 700 using hardware, software, firmware, tangible computer readable media having instructions stored thereon, or a combination thereof and may be implemented in one or more computer systems or other processing systems. Hardware, software or any combination of such may embody any of the modules/components in FIGS. 1-3 and any stage in FIG. 6.

If programmable logic is used, such logic may execute on a commercially available processing platform or a special purpose device. One of ordinary skill in the art may appreciate that embodiments of the disclosed subject matter can be practiced with various computer system and computer-implemented device configurations, including smartphones, cell phones, mobile phones, tablet PCs, multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor ‘cores.’

Various embodiments of the invention are described in terms of this example computer system 700. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. As will be appreciated by persons skilled in the relevant art, processor device 704 may also be a single processor in a multi-core/multiprocessor system, such system operating alone, or in a cluster of computing devices operating in a cluster or server farm. Processor device 704 is connected to a communication infrastructure 706, for example, a bus, message queue, network or multi-core message-passing scheme.

Computer system 700 also includes a main memory 708, for example, random access memory (RAM), and may also include a secondary memory 710. Secondary memory 710 may include, for example, a hard disk drive 712, removable storage drive 714 and solid state drive 716. Removable storage drive 714 may comprise a floppy disk drive, a magnetic tape drive, an optical disk drive, a flash memory, or the like. The removable storage drive 714 reads from and/or writes to a removable storage unit 718 in a well known manner. Removable storage unit 718 may comprise a floppy disk, magnetic tape, optical disk, etc. which is read by and written to by removable storage drive 714. As will be appreciated by persons skilled in the relevant art, removable storage unit 718 includes a computer usable storage medium having stored therein computer software and/or data.

In alternative implementations, secondary memory 710 may include other similar means for allowing computer programs or other instructions to be loaded into computer system 700. Such means may include, for example, a removable storage unit 722 and an interface 720. Examples of such means may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Communications interface 724 may include a modem, a network interface (such as an Ethernet card), a communications port, a PCMCIA slot and card, or the like. Software and data transferred via communications interface 724 may be in the form of signals, which may be electronic, electromagnetic, optical, or other signals capable of being received by communications interface 724. These signals may be provided to communications interface 724 via a communications path 726. Communications path 726 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 718, removable storage unit 722, and a hard disk installed in hard disk drive 712. Computer program medium and computer usable medium may also refer to memories, such as main memory 708 and secondary memory 710, which may be memory semiconductors (e.g. DRAMs, etc.).

Computer programs (also called computer control logic) are stored in main memory 708 and/or secondary memory 710. Computer programs may also be received via communications interface 724. Such computer programs, when executed, enable computer system 700 to implement the present invention as discussed herein. In particular, the computer programs, when executed, enable processor device 704 to implement the processes of the present invention, such as the stages in the method illustrated by flowchart 600 of FIG. 6 discussed above. Accordingly, such computer programs represent controllers of the computer system 700. Where the invention is implemented using software, the software may be stored in a computer program product and loaded into computer system 700 using removable storage drive 714, interface 720, hard disk drive 712 or communications interface 724.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### CONCLUSION

Embodiments described herein provide methods and apparatus for providing a light-weight network traffic cache. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A network traffic cache apparatus for improving the user experience of an application comprising:
a database operated on a client device;
a device I/O module operated on the client device configured for connecting to a remote server device;
an application operated on the client device, wherein the application is configured to send and receive information to and from the server device through the device I/O module; and
a traffic cache manager,
wherein upon an occurrence of a requirement for information by the application from the server device, the application is configured to submit a request for information substantially simultaneously to both the device I/O module and the traffic cache manager, and
wherein the traffic cache manager is configured to provide information to the application responsive to the request for information, the information being retrieved from the database.

2. The network traffic cache apparatus of claim 1, wherein the information provided from the traffic cache manager is provided to the application before any information responsive to the request for information is provided to the application from the device I/O module.

3. The network traffic cache apparatus of claim 1, wherein the database is a HTML5 client-side database, the application is a mobile application and the client device is a mobile device.

4. The network traffic cache apparatus of claim 1, wherein the request for information submitted to the device I/O module is substantially identical to the request for information submitted to the traffic cache.

5. The network traffic cache apparatus of claim 1 wherein the information provided to the application from the traffic cache manager comprises an unparsed string containing multiple pieces of information.

6. The network traffic cache apparatus of claim 1 wherein the database comprises:
a database schema comprising first column corresponding to a type of request for information a second column corresponding to an unparsed information response, wherein each row of the database corresponds to a different network request type; and
a set of data stored according to the database schema.

7. The network traffic cache apparatus of claim 1, further comprising wherein upon the application receiving information from the server device responsive to the request for information, the traffic cache manager logic is configured to store the information in the database.

8. The network traffic cache apparatus of claim 7 wherein the information stored in the database comprises a type of the information received and the information received.

9. A method of improving an application user experience with a light-weight network traffic cache comprising:
submitting, with an application on a client device, a request for information to a server device, the request for information being of a first type of request;
receiving from the server device, information responsive to the request for information at both the application and a traffic cache manager on the client device;
storing, with the traffic cache manager, the information in a database on the client device;
upon starting up of the application, substantially simultaneously sending a request for information to both the server device and the traffic cache manager, the request for information being of the first type of request;
retrieving, by the traffic cache manager, information from the database responsive to the request for information; and
sending by the traffic cache manager, the information responsive to the request for information to the application.

10. The method of claim 9 wherein the information responsive to the request for information is provided by the traffic cache manager to the application before the information is provided to the application by the device I/O module.

11. The method of claim 9, wherein the database is an HTML5 client-side database, the application is a mobile application and the client device is a mobile device.

12. The method of claim 9, wherein the request for information submitted to the server device is substantially identical to the request for information submitted to the traffic cache manager.

13. The method of claim 9 wherein the information provided to the application from the traffic cache manager comprises an unparsed string containing multiple pieces of information.

14. The method of claim 9 wherein the database comprises:
a database schema comprising first column corresponding to a type of network request a second column corresponding to an unparsed network response, wherein each row of the database corresponds to a different network request type; and
a set of data stored according to the database schema.

15. The method of claim 9 wherein the request information stored in the database comprises the type of request and the information received responsive to the request.

16. A network traffic cache layer apparatus for improving the user experience of an application comprising;
a database operated on a client device;
a traffic cache layer manager operated on the client device; and
an application operated on the client device, wherein the application is configured to send and receive information to and from the server device through the traffic cache layer manager;
wherein upon the occurrence of a requirement for information from the server device by the application, the application is configured to submit a request for information substantially simultaneously to the traffic cache layer manager, and
wherein the traffic cache layer manager is configured to provide information to the application responsive to the request for information, the information being retrieved from the database, and
wherein the traffic cache layer manager is further configured to submit a request to the server device corresponding to the request for information submitted by the application, and
wherein upon the receipt of a response from the server device, the traffic cache layer manager is configured to substantially simultaneously provide the response to the application and store the response in the database.

17. The network traffic cache layer apparatus of claim 16, wherein the database is a HTML5 client-side database, the application is a mobile application and the client device is a mobile device.

18. The network traffic cache layer apparatus of claim 16 wherein the stored response from the server device comprises a type of response and an unparsed response portion of the response from the server device.
